(19) United States
(12) Patent Application Publication
(10) Pub. No.: US 2020/0308024 A1
(43) Pub. Date: Oct. 1, 2020

(54) Method for the ultraviolet stabilization of chlorine dioxide in aqueous systems

(71) Applicant: Truox, Inc., McClellan, CA (US)

(72) Inventor: Roy W. Martin, Downers Grove, IL (US)

(21) Appl. No.: 16/501,622

(22) Filed: May 10, 2019

Related U.S. Application Data
(63) Continuation-in-part of application No. 16/501,355, filed on Mar. 28, 2019.

(51) Int. Cl. C02F 1/32; C02F 1/76

(52) U.S. Cl. CPC C02F 1/32; C02F 2103/42; C02F 1/76

(57) ABSTRACT

Disclosed is a method for treating an aqueous system exposed to the sunlight with chlorine dioxide while inhibiting the UV degradation of chlorine dioxide.

### FIELD OF INVENTION

This invention relates to methods and compositions for enhanced sanitation and oxidation of aqueous solutions, such as aquatic facilities and methods for their use.

### BACKGROUND OF THE TECHNOLOGY

Aquatic facility popularity has risen dramatically over the last few decades. This is especially evident in the area of recreational water exemplified by Water Parks and development of feature pools at Park Districts and resorts. To ensure that the aquatic facilities can be enjoyed safely, the water must be treated to reduce or eliminate various pathogens such as bacteria, viruses and parasitic organisms.

Coliform bacteria are defined as rod-shaped Gram-negative non-spore forming and motile or non-motile bacteria which can ferment lactose with the production of acid and gas when incubated at 35-37° C. They are a commonly used indicator of sanitary quality of foods and water. Coliforms can be found in the aquatic environment, in soil and on vegetation; they are universally present in large numbers in the feces of warm-blooded animals. While coliforms themselves are not normally causes of serious illness, they are easy to culture, and their presence is used to indicate that other pathogenic organisms of fecal origin may be present. Such pathogens include disease-causing bacteria, viruses, or protozoa and many multicellular parasites. Coliform procedures are performed in aerobic or anaerobic conditions. Typical genera include: Citrobacter, Enterobacter, Hafnia, Klebsiella, Escherichia

Escherichia coli (E. coli) can be distinguished from most other coliforms by its ability to ferment lactose at 44° C. in the fecal coliform test.

Recreational Water Illness (RWI) is a term used by the Center for Disease Control and Prevention (CDC) to describe the various illnesses contracted by humans during exposure to aquatic facilities such as Water Parks, swimming pools and the like.

Standard concentrations of chlorine used to treat recreational water (typically 1-3 mg/l as Cl₂) are sufficient to achieve a high rate of kill of most microbiological organisms introduced to the water of aquatic facilities. According to the CDC, E. coli, Norovirus, Giardia and other microbiological organisms account for no more than 20% of all RWI incidences combined. However, Cryptosporidium parvum accounts for nearly 80% of all reported RWI incidences in the United States. The high incidence of RWI attributed to Cryptosporidium parvum is the result of its high tolerance to chlorine.

To illustrate the level of chlorine tolerance, exposing E. coli to 1 mg/l of chlorine will typically achieve a 6-log kill in less than 1 minute. This equates to a Ct value of 1 mg-min/ltr. In contrast, the CDC reports it requires at Ct value of 15,600 mg-min/ltr to achieve a 3-log kill of Cryptosporidium parvum. This would require 40 mg/l of chlorine for 6.5 hours. As a result, the CDC reported Cryptosporidium parvum can survive in the water of an aquatic facility treated with normal levels of chlorine for 10 days, potentially exposing thousands of visitors over that period.

Cryptosporidium parvum (“Crypto”) contamination of an aquatic facility is the result of fecal discharge into the water by a person or animal infected.

To address this problem, the industry has implemented a treatment approach known as hyperchlorination. The hyperchlorination process requires isolating the aqueous system from human contact and treating with high concentrations of chlorine (i.e. 40 mg/l as Cl₂). At this concentration, it requires at least 6.5 hours of reaction time to achieve a 3-log kill based on the 15,600 mg·min/ltr Ct value, and 8.5 hours with 15 mg/l of cyanuric acid (UV stabilizer) based on CDC guidelines.

The economic impact to commercial water parks and pools that must close and often return admittance fees is devastating.

A new method for inactivating Crypto is needed to provide rapid remediation of the aqueous system in an expeditious manner to allow for prompt reopening to patrons.

### SUMMARY OF THE INVENTION

The referenced cyclic process provides for a means of in-situ generation of chlorine dioxide that is extremely useful in accelerating the inactivation of Crypto. However, while the cyclic process offers many benefits over existing methods for killing Crypto, it does require time to generate the chlorine dioxide. Furthermore, the exposure of chlorine dioxide to sunlight comprising ultraviolet light (also referred to as “UV”) quickly decomposes the chlorine dioxide generated by the cyclic process.

A method has been developed to accelerate the generation of chlorine dioxide during normal daylight hours when most recreational water facilities are being visited by exploiting the benefits of sunlight's UV to accelerate the generation of chlorine dioxide.

Addition of chlorite donor to the aqueous system exposed to sunlight results in generation of chlorine dioxide by ultraviolet decomposition of chlorite anions according to the proposed stoichiometry:

3ClO₂⁻+H₂O+hv→Cl⁻+2ClO₂+2OH⁻+0.5O₂

This method of generating chlorine dioxide dramatically reduces the time required to produce chlorine dioxide in a large body of water common to water parks. However, as previously disclosed, the chlorine dioxide produced is susceptible to ultraviolet (UV) degradation. To reduce the rate of UV degradation of chlorine dioxide, UV absorption chemistry is applied to the aqueous system that absorbs UV in the same wavelength range as chlorine dioxide.

### BRIEF DESCRIPTION OF THE FIGURES

FIG. 1 shows the UV absorbance spectra of Disodium Distyrylbiphenyl Disulfonate (DDBD) at a concentration of 4 mg/l in distilled H₂O.

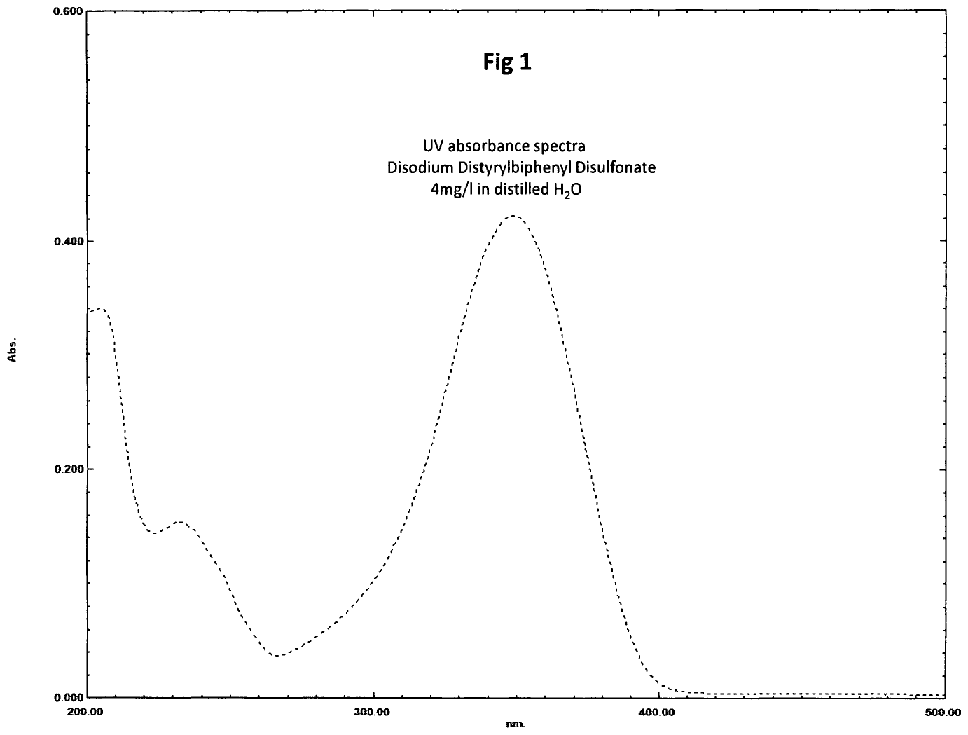

FIG. 2 illustrates how the UV spectra of chlorite anion overlays that of UV absorbent DDBD. The chlorite anion is provided virtually no UV protection.

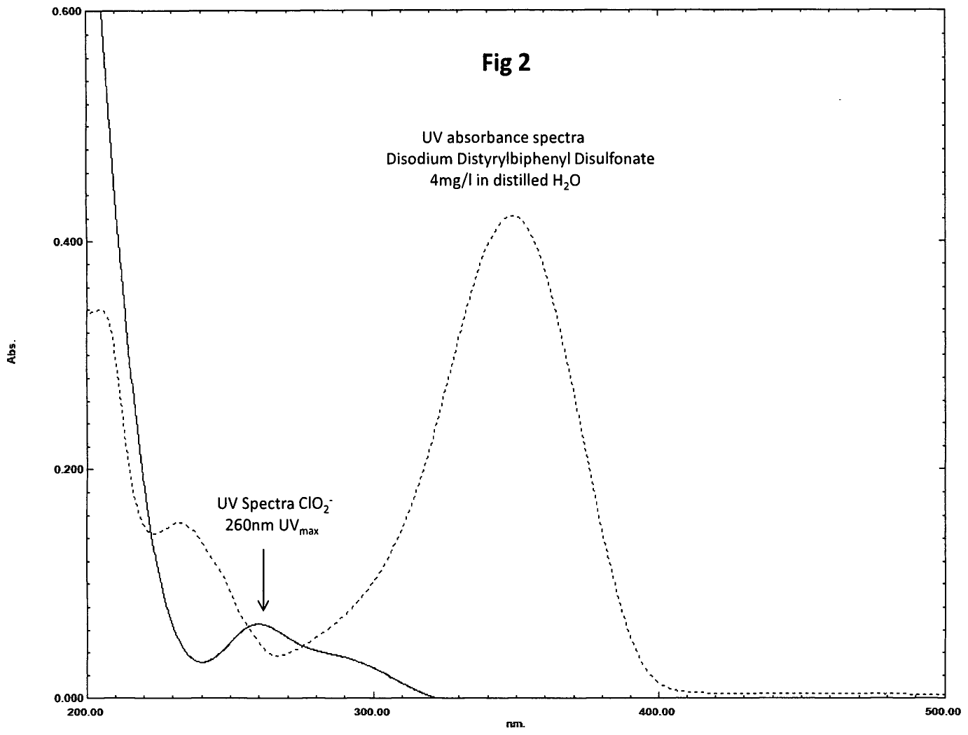

FIG. 3 illustrates the presence of chlorine dioxide with UVₘₐₓ at 360 nm wavelength. The overwhelming portion of the ClO₂ UV spectra is covered by the dome of UV protection provided by the DDBD.

FIG. 4 shows the increasing concentration of chlorine dioxide resulting from the cyclic process which remains protected by the dome of UV absorbent DDBD.

FIG. 5 illustrates the UV spectra of Avobenzone that effectively protects both the chlorite anion UVₘₐₓ of 260 nm as well as the chlorine dioxide UVₘₐₓ at 360 nm.

FIG. 6 illustrates the cyclic process.

### DETAILED DESCRIPTION OF THE INVENTION

In the first embodiment, disclosed is a method for treating an aqueous system with chlorine dioxide while exposed to sunlight, the method comprising: adding to the aqueous system an effective amount of UV absorbent and chlorine dioxide; inhibiting UV degradation of chlorine dioxide by absorbing UV with the UV absorbent; sustaining a chlorine dioxide concentration to obtain a Ct value, and wherein the Ct value is sufficient to achieve remediation.

In the second embodiment, disclosed is a method for treating an aqueous system with chlorine dioxide while exposed to sunlight, the method comprising: adding to the aqueous system an effective amount of UV absorbent and chlorite donor; generating chlorine dioxide by UV decomposition of chlorite; inhibiting UV degradation of chlorine dioxide by absorbing UV with the UV absorbent; sustaining a chlorine dioxide concentration to obtain a Ct value, and

wherein the Ct value is sufficient to achieve remediation.

In the third embodiment, disclosed is a method for treating an aqueous system with chlorine dioxide while exposed to sunlight, the method comprising: adding to the aqueous system an effective amount of UV absorbent and chlorite donor; generating chlorine dioxide using the cyclic process; inhibiting UV degradation of chlorine dioxide by absorbing UV with the UV absorbent; sustaining a chlorine dioxide concentration sufficient to obtain a Ct value, and

wherein the Ct value is sufficient to achieve remediation.

In the fourth embodiment, disclosed is a method for treating and aqueous system with chlorine dioxide while exposed to sunlight, the method comprising: a composition comprising an aqueous solution of chlorite donor, sodium borate and a UV absorbent; addition of the composition to the aqueous system; generating chlorine dioxide by exposing the chlorite to UV and/or using the cyclic process; inhibiting UV degradation of chlorine dioxide by absorbing UV with the UV absorbent; sustaining a chlorine dioxide concentration sufficient to obtain a Ct value, and

wherein the Ct value is sufficient to achieve remediation.

In accordance with the first, second, third and fourth embodiments the aqueous system comprises recreational water.

In accordance with the first, second, third and fourth embodiments the aqueous system comprises a cooling tower.

### Prior Art:

U.S. Pat. Nos. 7,922,933, 7,927,509, and 7,976,725 which are herein incorporated by reference in their entirety, disclose a cyclic process for the in-situ generation of chlorine dioxide. The cyclic process utilizes bromide ions that are activated by an oxidant to produce free bromine. The free bromine oxidizes chlorite ions producing chlorine dioxide. Chlorine dioxide inactivates microbiological organisms (i.e. Cryptosporidium). During this process the free bromine and at least some portion of the chlorine dioxide are reduced back to bromide ions and chlorite ions respectively which are recycled back to free bromine and chlorine dioxide utilizing the cyclic process.

U.S. Pat. Nos. 4,414,180 and 4,456,511 disclose a chlorine dioxide generator and method for generating chlorine dioxide gas from an aqueous solution of sodium chlorite through photochemical oxidation. The generator produces chlorine dioxide by exposing the sodium chlorite solution to UV radiation using a UV generating lamp to produce chlorine dioxide while continuously sparging the solution with gas to remove the chlorine dioxide before it is decomposed by the UV.

### Definitions:

As used herein “while exposed to sunlight” describes the ability of invention to perform under conditions (i.e. UV) that could compromise the treatment program. It is not intended the disclosed invention can only be applied during daylight (sunlight) hours.

As used herein the term “Ct value” is defined as the product of the average concentration of an oxidant (mg/l) and time (minutes) of exposure to the oxidant. For example, if the average chlorine dioxide concentration of ClO₂ is determined to be 2.2 mg/l over a 20 minute period of time, the Ct value is calculated by multiplying the average concentration of chlorine dioxide by the time.

Ct value=2.2 mg/l×20 min

Ct value=44 mg·min/l

The Ct value can be targeted based on laboratory and/or field studies to achieve the desired level of inactivation. Comparatively, low Ct values (i.e. Ct=1 mg·min/l) may achieve a 6-log reduction in bacteria like E. coli, while higher Ct values (i.e. Ct=90 mg·min/l) may be required to reduce a parasite like Cryptosporidium by 3-log.

As used herein, the term “free chlorine” is used with reference to a chlorine source that hydrolyses in the aqueous system to produce at least some portion of hypochlorous acid.

As used herein, the term “free bromine” is used with reference to the formation or presence of hypobromous acid and possibly some portion of hypobromite ions.

As used herein, the term “oxidizing activator” is used with reference to an oxidizer selected from at least one of: free chlorine, peroxymonosulfate, alkali metal salts or ammonium salts of persulfates and electrolysis; wherein when the activating oxidizer is introduced to the aqueous system comprising bromide anions, the activating oxidizer reacts with bromide anion resulting in the formation of free bromine.

As used herein, the term “inactivation” and “inactivate” is used with reference to the ability to kill or destroy microbiological organisms.

As used herein, the term “microbiological organisms” is used with reference to all forms of microbiological life forms including: parasites, bacteria, viruses, algae, fungus, and organisms encased in biofilms.

As used herein, the term “free halogen donor” is used with reference to a halogen source which acts as an active oxidizer when dissolved in water. Chlorine based free halogen donors form at least one of Cl₂, HOCl, and OCl⁻ (also referred to as free chlorine) when added to water, whereby the species formed is pH dependent. Bromine based free halogen donors form at least one of Br₂, HOBr, and OBr⁻ (also referred to as free bromine), again the species being pH dependent.

As used herein, the term “aquatic facility” is used with reference to all structural components and equipment comprising an aqueous system used by humans for exercise, sports and/or recreation. Examples of aquatic facilities include but are not limited to: residential swimming pools, water parks, theme parks, swimming pools, spas, therapy pools, hot tubs and the like.

As used herein, the term “aqueous system” describes a body of water that can be treated using the disclosed invention. Examples of aqueous systems include recreational water, cooling towers, cooling ponds and wastewater.

As used herein, “recreational water” is water used by humans for various activities such as swimming, exercise, water sports, recreation, physical therapy and diving. Examples of aqueous systems comprising recreational water include: swimming pools, hot tubs, feature pools, spas, water-park rides, therapy pools, diving wells etc.

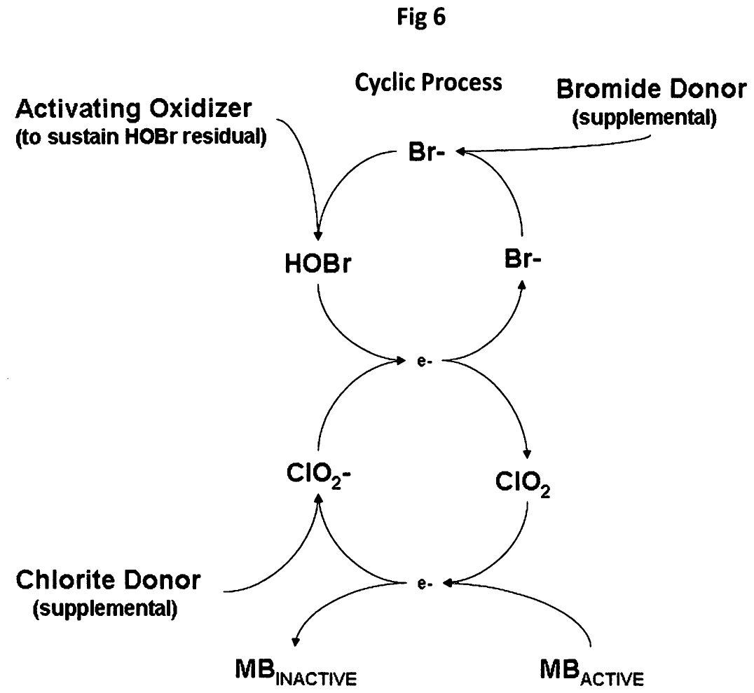

As used herein, the term “cyclic process” relates to the recycling of substantially inert anions comprising bromide and chlorite into their oxyhalogen surrogates, exemplified by hypobromous acid and chlorine dioxide respectfully followed by reduction back to their respective anions, and where the process is repeated (FIG. 6).

As used herein, the term “chlorite anion donor” and “chlorite donor” is a compound that comprises an alkali metal salt comprising chlorite anions ClO₂⁻, chlorine dioxide, or any convenient direct or indirect source of chlorite anions. For example, chlorine dioxide can indirectly produce chlorite due to reduction in an aqueous system. Sodium chlorite directly supplies chlorite anions.

As used herein, the term “chlorite anion” (also referred to as “chlorite”) comprises chlorite having the general formula ClO₂⁻.

As used herein, the term “recycled” means at least some portion of the recovered bromide anions and chlorite anions are regenerated to their respective oxyhalogen compounds, followed by reduction back to their respective anions, and where the process is repeated.

As used herein, the term “Cryptosporidium” is used to represent any form of parasitic microbiological organism from the family of Cryptosporidium. An example of Cryptosporidium is Cryptosporidium parvum (also referred to as C. parvum, C. parvum and Cryptosporidium parvum). Other examples of Cryptosporidium include but are not limited to: C. hominis, C. canis, C. felis, C. meleagridis, and C. muris. It is to be noted that inclusion or exclusion of italic characters or print when referring to Cryptosporidium or any of its many variants does not in any way detract from its intended descriptive meaning.

As used herein, the term “microbiological organisms” is used with reference to all forms of microbiological life including: parasites, bacteria, viruses, algae, fungus, and organisms encased in biofilms.

As used herein, “parasites” includes any species of organism including Cryptosporidium, Giardia and Ameba that can be transferred to humans by water and cause waterborne parasitic disease in humans.

As used herein, the term “inactivation” is used with reference to the ability to deactivate, kill, or destroy microbiological organisms.

As used herein, “remediation” is used with reference to achieving the Ct value necessary to render the aqueous system free of coliform bacteria &/or at least a 3-log reduction (inactivation) of parasites. Remediation is also used in reference to the ability to render the aqueous system free of algae.

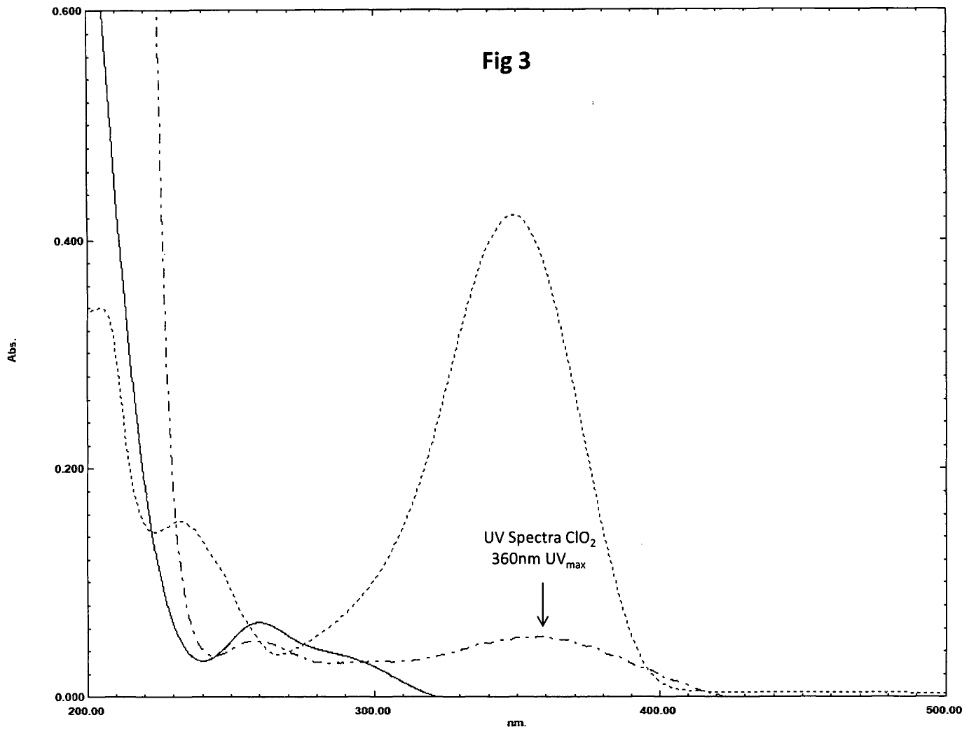

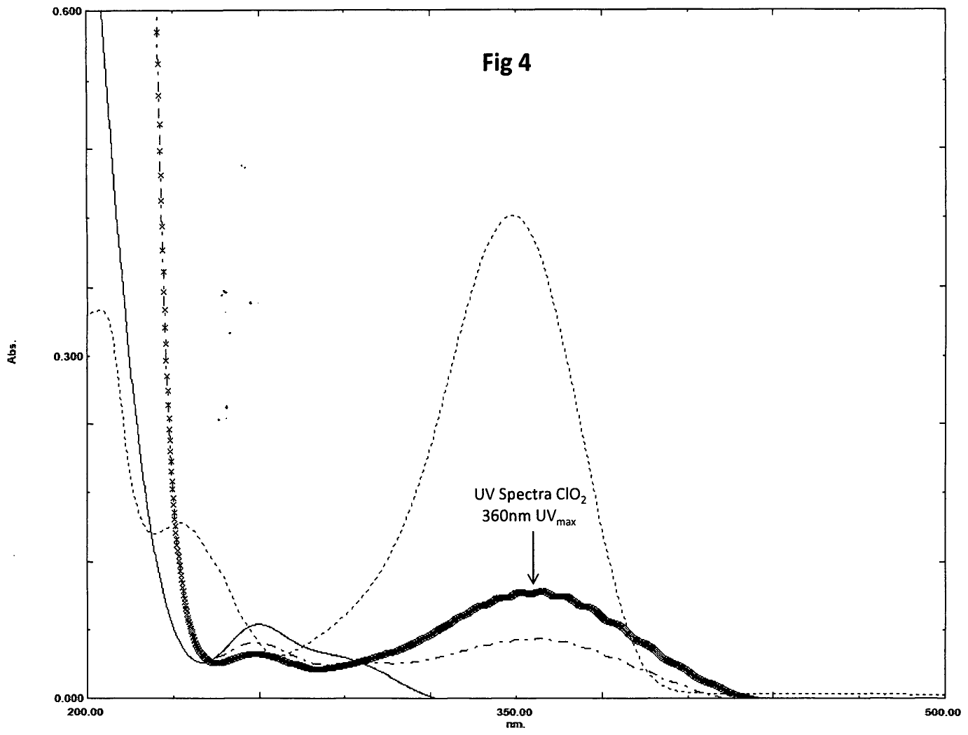

As used herein “UV absorbent” describes chromophores capable of absorbing UV in the wavelengths that include at least some portion of the chlorine dioxide UV spectrum. The UV absorbent absorbs ultraviolet radiation in the range of wavelengths that include greater than 25%, preferably greater than 50% and most preferably greater than 75% of the chlorine dioxide UV absorbance spectrum. Referring to FIGS. 3 and 4, the UV absorbance spectrum of DDBD clearly encompasses the majority of chlorine dioxide UV absorbance spectrum.

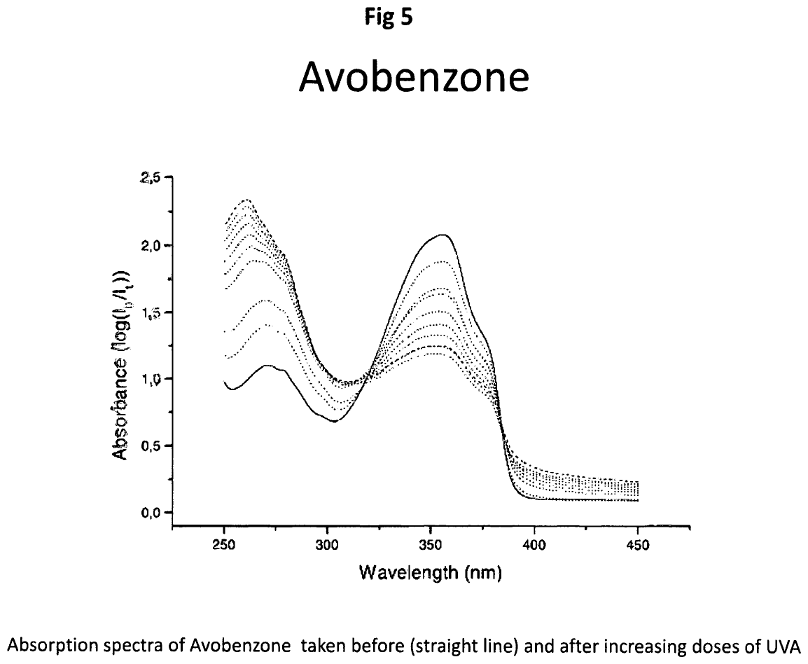

As used herein “chlorite-UV absorbent” comprise chromophores that absorb ultraviolet radiation in the range of wavelengths that include greater than 25%, preferably greater than 50% and most preferably greater than 75% of the chlorite UV absorbance spectrum. Referring to FIG. 5, the UV absorbance spectrum of Avobenzone clearly encompasses the majority of chlorite UV absorbance spectrum.

As used herein “effective amount of UV absorbent” is the concentration of UV absorbent needed to sufficiently inhibit UV degradation (also referred to as photo-degradation) of chlorine dioxide in order to achieve remediation.

### Discussion

Sunlight comprises electromagnetic radiation in various wavelengths ranging from infrared, visible and ultraviolet light (UV).

UV absorbents can absorb UV in a range of wavelengths. UV can be categorized into wavelength based groups. The groups of interest as they pertain to this disclosure include: UVA (315-400 nm), UVB (280-315 nm) and UVC (100-280 nm).

The amount of UV absorbent needed to obtain adequate UV protection depends on the UV absorbents used. As illustrated in FIGS. 3 and 4, the amplitude of the absorbance spectrum provided by 4 mg/l of DDBD was approximately 4-times greater than the amplitude of the chlorine dioxide absorbance. This illustrates that even at relatively low concentrations DDBD can provide significant protection from UV degradation of chlorine dioxide resulting from exposure to sunlight. If greater protection is desired, higher concentrations of DDBD and/or other UV absorbents can be applied.

Another factor to consider when determining the amount of UV absorbent is the concentration of chlorine dioxide desired, the contact time required to achieve the Ct value necessary to remediate the aqueous system and the intensity of the UV.

Referring to FIG. 4, the data illustrates the amplitude of the UV absorbance for chlorine dioxide (360 nm is the UVₘₐₓ for chlorine dioxide) increases with concentration. So if higher concentrations of chlorine dioxide are desired to reduce the time required to achieve the Ct value, it may be necessary to increase the concentration of UV absorbent to adequately protect the chlorine dioxide from the sun's UV.

It is desirable to apply UV absorbent in sufficient concentration to inhibit the UV decomposition of the chlorine dioxide in order to achieve the desired treatment effect. The level of UV inhibition depends on the concentration of chlorite donor being applied, the intensity of the UV radiation and the like.

Typically the UV absorbent is applied to the aqueous system to achieve from 0.005 to 10 ppm, more preferred 0.01 to 6 ppm and most preferred 0.02 to 4 ppm.

UV absorbents comprise organic chromophores that absorb various wavelengths of light in the UV spectrum. Common examples of UV absorbents are sunscreens and optical brighteners used in laundry treatments to improve whitening of fabrics. The range of UV absorbance can vary significantly from compound to compound. Furthermore, the solubility of the compound, stability to oxidizers (e.g. chlorine and chlorine dioxide) as well as UV degradation varies from compound to compound. The selection of the UV absorbents can be altered and blended to take advantage of the differences.

For example, as illustrated in FIG. 5, avobenzone undergoes photo-degradation when exposed to UVA. When avobenzone is applied to recreational water to protect chlorine dioxide during a remediation treatment, the UV absorbent will provide protection to the chlorine dioxide whether directly applied or generated in-situ (cyclic process &/or UV degradation of chlorite) in the aqueous system. However, under conditions of continued bombardment from UVA resulting from exposure to sunlight, the avobenzone with degrade, preventing accumulation resulting from ongoing remediation treatments. This would be considered an advantage since it provides the needed benefit to allow for the remediation of the aqueous system by protecting the chlorine dioxide, but is then degraded post remediation treatment.

The solubility of UV absorbents ranges from very water soluble to virtually insoluble in water. For example, DDBD is water soluble and will readily dissolve in aqueous solutions. However, avobenzone solubility is reported to be 2.2 mg/l. While 2 mg/l of avobenzone will provide good UV absorbance in many applications, its limited solubility offers greater potential. Forming a hydrophobic film of UV absorbent on top of the aqueous system provides a means of inhibiting UV degradation of chlorine dioxide &/or chlorite in the water by absorbing the UV on the water's surface before it penetrates the water. Furthermore, this method greatly reduces the interaction between oxidizers in the water and the UV absorbent so the UV absorbents not resistant to oxidizers like chlorine dioxide will not experience as much chemical degradation. Further still, this method of application may reduce the overall concentration of UV absorbent by coating only the surface of the water with a comparatively high concentration of UV absorbent rather than having to treat the entire volume of water.

The use of UV absorbents is also beneficial while incorporating the cyclic process for the in-situ generation of chlorine dioxide. The cyclic process utilizes bromide ions that are activated by an oxidant such as chlorine or potassium monopersulfate to produce free bromine. The free bromine oxidizes chlorite ions producing chlorine dioxide. Chlorine dioxide inactivates microbiological organisms (i.e. Cryptosporidium). During this process the free bromine and at least some portion of the chlorine dioxide are reduced back to bromide ions and chlorite ions respectively which are recycled back to free bromine and chlorine dioxide utilizing the cyclic process. By inhibiting the UV degradation of chlorine dioxide and chlorite, the cyclic process can be carried out during daytime hours without rapid degradation of the chlorine dioxide and accelerated UV degradation of the chlorite. The cyclic process is therefore able to provide a continued and relatively consistent concentration of chlorine dioxide throughout the day.

Mixtures of UV absorbents can be blended together to provide the desired UV absorbance as well as desired features already disclosed. Suitable solvents can be selected for form solutions, slurries, emulsions and the like. The consistency and solubility is limited by the formulator. Depending on the UV absorbents solubility profile, non-limiting examples of solvents include: water, methanol, ethanol, isopropyl alcohol, acetone, DMSO, mineral oil and the like. Surfactants can be used to form emulsions. Examples of surfactants include ethoxylated alcohols, ethylene and propylene block copolymers and the like.

Non-limiting examples of UV absorbents include: Disodium Distyrylbiphenyl Disulfonate (DDBD), 2,4-dihydroxybenzophenone, 2,2′,4,4′-tetrahydroxybenzophenone, 2-hydroxy-4-methoxybenzophenone, 5-benzoyl-4-hydroxy-2-methoxy monosodium salt, 5-methyl-2-(1-methyl-ethyl)-2-aminobenzoate, 2-Ethoxyethyl-para-methoxycinnamate, para-methoxyhydroxycinnamate, Amyl-4-methoxycinnamate, Amyl para-N,N-dimethylaminobenzoate, ethyl-4-bis(2-hydroxypropyl) aminobenzoate, 4,4′-Diamino-2,2′-stilbenedisulfonic acid, 4 4′-bis(benzoxazolyl)-cis-stilbene, 2 5-bis(benzoxazol-2-yl)thiophene, tetrasodium 4,4′-bis[[4-[bis(2-hydroxyethyl)amino]-6-(4sulphonatoanilino)-1,3,5-triazin-2-yl]amino]stilbene-2,2′-disulphonate] and the like. Preferred UV absorbents are low toxicity optical brighteners that undergo photo-degradation when exposed to UV. Non-limiting examples of suitable optical brighteners include: Disodium Distyrylbiphenyl Disulfonate (DDBD), tetrasodium 4,4′-bis[[-[bis(2-hydroxyethyl)amino]-6-(4sulphonatoanilino)-1,3,5-triazin-2-yl]amino]stilbene-2,2′-disulphonate], 4,4′-diamino-2,2′-stilbenedisulfonic acid and 4,4′-Bis[4-[bis(2-hydroxyethyl)amino]-6-anilino-1,3,5-triazin-2-yl]amino]stilbene-2,2′-disulphonic acid.

Compositions of the invention comprise an aqueous solution of chlorite donor, borate donor and UV absorbent. It has been discovered that oxidizers like sodium chlorite can be safely combined with organic compounds like UV absorbents when an effective amount of borate donor is incorporated into the composition without concern of deflagration or detonation resulting from decomposition of the chlorite.

The chlorite donor can range between 1 to 15 wt %, preferably 2 to 12 wt % and most preferred 5 to 10 wt % reported as NaClO₂. If another chlorite donor is used (i.e. KClO₂) then the wt % should be optimized based on the NaClP₂ as the standard.

The borate donor is added to achieve an effective weight percent (wt %) ratio to chlorite donor. The composition comprises an aqueous solution of chlorite donor (reported as NaClO₂) and borate donor (reported as B₂O₃), wherein the weight percent (wt %) ratio of NaClO₂ to B₂O₃ is less than 2.5:1 (wt/wt), more preferably less than 2:1 and most preferred less than 1.5:1 respectively.

Non-limiting examples of borate donors include: sodium tetraborate decahydrate, sodium tetraborate pentahydrate, disodium octaborate tetrahydrate, potassium pentaborate tetrahydrate, potassium tetraborate tetrahydrate, sodium metaborate dehydrate and sodium metaborate tetrahydrate. Preferred borate donors include sodium metaborate dehydrate and sodium metaborate tetrahydrate. The preferred borate donors are hydrates that buffer the pH above 11 and impart a stabilized source of water if/when the composition is dried to a crystallized form.

In addition to the borate donor, additional alkali such as sodium hydroxide and potassium hydroxide can be added to further elevate the pH in the event the borate donor buffers the pH below that required to stabilize the chlorite donor (i.e. approximately pH 11.0+).

The compositions of the invention are produced by combining a chlorite donor to an aqueous solution of borate donor to achieve the desired ratio of chlorite (as NaClO₂) to borate donor (as B₂O₃). The UV absorbent can be added before or after the chlorite donor blending with the aqueous solution of borate donor. Additional surfactants and/or hydrotropes can be added to assist with low solubility UV absorbents.

### EXAMPLE

To 49 grams distilled water 1 gram of tetrasodium 4,4′-bis[[4-[bis(2-hydroxyethyl)amino]-6-(4sulphonatoanilino)-1,3,5-triazin-2-yl]amino]stilbene-2,2′-disulphonate] was added and mixed until dissolved. Then 10 grams of sodium metaborate tetrahydrate was added mixed until dissolved. To the clear yellow solution, 40 grams of 25 wt % sodium chlorite was added and allowed to mix for 10 minutes to form a composition.

2000 ml of tap water (pH ˜7.9) was added to a glass beaker into which 10 μl of composition (equivalent to 0.37 ppm as ClO₂) was added and thoroughly mixed. The beaker was placed in direct sunlight. After 70 minutes and 240 minutes samples were taken and tested for chlorine dioxide using a low range lissamine green test kit from Palin Test. The test results showed 0.34 ppm as ClO₂ after 70 minutes and 0.25 ppm ClO₂ after 240 minutes.

It is claimed:

1. A method for treating an aqueous system with chlorine dioxide while exposed to sunlight, the method comprising: adding to the aqueous system an effective amount of UV absorbent and chlorine dioxide; inhibiting UV degradation of chlorine dioxide by absorbing UV with the UV absorbent; sustaining a chlorine dioxide concentration to obtain a Ct value, and
wherein the Ct value is sufficient to achieve remediation.

2. The method in accordance with claim 1, wherein remediation renders the aqueous system free of coliform bacteria.

3. The method in accordance with claim 1, wherein remediation achieves at least a 3-log reduction of parasite.

4. The method in accordance with claim 3, wherein the parasite comprises Cryptosporidium.

5. The method in accordance with claim 3, wherein the parasite comprises Giardia.

6. The method in accordance with claim 3, wherein the parasite comprises Ameba.

7. The method in accordance with claim 1, wherein remediation renders the aqueous system free of algae.

8. The method in accordance with claim 1, wherein the aqueous system comprises recreational water.

9. A method for treating an aqueous system with chlorine dioxide while exposed to sunlight, the method comprising: adding to the aqueous system an effective amount of UV absorbent and chlorite donor; generating chlorine dioxide by ultraviolet decomposition of chlorite; inhibiting UV degradation of chlorine dioxide by absorbing UV with the UV absorbent;
sustaining a chlorine dioxide concentration to obtain a Ct value, and wherein the Ct value is sufficient to achieve remediation.

10. The method in accordance with claim 9, wherein remediation renders the aqueous system free of coliform bacteria.

11. The method in accordance with claim 9, wherein remediation achieves at least a 3-log reduction of parasite.

12. The method in accordance with claim 11, wherein the parasite comprises Cryptosporidium.

13. The method in accordance with claim 11, wherein the parasite comprises Giardia.

14. The method in accordance with claim 11, wherein the parasite comprises Ameba.

15. The method in accordance with claim 9, wherein remediation renders the aqueous system free of algae.

16. The method in accordance with claim 9, wherein the aqueous system comprises recreational water.

17. A method for treating an aqueous system with chlorine dioxide while exposed to sunlight, the method comprising: adding to the aqueous system an effective amount of UV absorbent and chlorite donor; generating chlorine dioxide using the cyclic process; inhibiting UV degradation of chlorine dioxide by absorbing UV with the UV absorbent; sustaining a chlorine dioxide concentration sufficient to obtain a Ct value, and wherein the Ct value is sufficient to achieve remediation.

18. The method in accordance with claim 17, wherein remediation renders the aqueous system free of coliform bacteria.

19. The method in accordance with claim 17, wherein remediation achieves at least a 3-log reduction of parasite.

20. The method in accordance with claim 19, wherein the parasite comprises Cryptosporidium.

21. The method in accordance with claim 19, wherein the parasite comprises Giardia.

22. The method in accordance with claim 19, wherein the parasite comprises Ameba.

23. The method in accordance with claim 17, wherein remediation renders the aqueous system free of algae.

24. The method in accordance with claim 17, wherein the aqueous system comprises recreational water.

25. A method for treating and aqueous system with chlorine dioxide while exposed to sunlight, the method comprising: a composition comprising an aqueous solution of chlorite donor, borate donor and a UV absorbent; addition of the composition to the aqueous system; generating chlorine dioxide by exposing the chlorite to UV and/or using the cyclic process; inhibiting UV degradation of chlorine dioxide by absorbing UV with the UV absorbent; sustaining a chlorine dioxide concentration sufficient to obtain a Ct value, and wherein the Ct value is sufficient to achieve remediation.

26. The method in accordance with claim 25, wherein remediation renders the aqueous system free of coliform bacteria.

27. The method in accordance with claim 25, wherein remediation achieves at least a 3-log reduction of parasite.

28. The method in accordance with claim 27, wherein the parasite comprises Cryptosporidium.

29. The method in accordance with claim 27, wherein the parasite comprises Giardia.

30. The method in accordance with claim 27, wherein the parasite comprises Ameba.

31. The method in accordance with claim 25, wherein remediation renders the aqueous system free of algae.

32. The method of claim 25, wherein the aqueous system comprises recreational water.

33. The composition in accordance with claim 25, wherein the chlorite donor comprises sodium chlorite.

34. The composition in accordance with claim 25, wherein the borate donor comprises sodium metaborate dehydrate.

35. The composition in accordance with claim 25, wherein the borate donor comprises sodium metaborate tetrahydrate.

36. The composition in accordance with claim 25, wherein the borate donor comprises disodium octaborate tetrahydrate.

37. The composition in accordance with claim 25, wherein the UV absorbent comprises an optical brightener.
